(19) United States
(12) Patent Application Publication
(10) Pub. No.: US 2004/0029557 A1
(43) Pub. Date: Feb. 12, 2004

(54) Method of monitoring a location and a mobile phone employing the same

(75) Inventor: Pierluigi Pugliese, Vaterstetten (DE)

Correspondence Address: HITT GAINES P.C., P.O. BOX 832570, RICHARDSON, TX, 75083, US

(73) Assignee: Agere Systems Inc., Allentown, PA

(21) Appl. No.: 10/391,121

(22) Filed: Mar. 18, 2003

(30) Foreign Application Priority Data
Mar. 27, 2002 (EP) 2007043.9

(51) Int. Cl. H04Q 7/00

(52) U.S. Cl. 455/404.2; 455/435.1; 455/456.1; 455/422.1; 455/456.2; 455/456.3; 455/456.6

(57) ABSTRACT

The present invention provides a method of monitoring a location and a mobile phone incorporating the same. In one embodiment, the method includes detecting a sound at a monitoring location and determining if the sound is above a predetermined threshold. The method also includes sending a message to a location distal from the monitoring location if the sound is above the predetermined threshold. In a related but alternative embodiment, the mobile phone includes a detector configured to detect a sound and a discriminator configured to determine if the sound is above a predetermined threshold. The mobile phone also includes a transmitter configured to send a message to a location distal from the mobile phone if the sound is above the predetermined threshold.

### CROSS-REFERENCE TO FOREIGN APPLICATION

This application claims the benefit of Patent Application No. 02007043.9 entitled “Alerting Method and Mobile Phone for Alerting” to Pierluigi Pugliese, filed with the European Patent Office on Mar. 27, 2002, which is incorporated herein by reference in its entirety.

### TECHNICAL FIELD OF THE INVENTION

The present invention is directed, in general, to communication systems and, more specifically, to a monitoring system, method of monitoring a location and a mobile phone employing the same.

### BACKGROUND OF THE INVENTION

Monitoring systems may be used to remotely listen to a particular location or for a certain person. For example, monitoring systems are commonly used by parents to listen to their children who may be in another room. A monitoring system may be placed in a baby's room to determine if the baby is sleeping and, if so, when the baby awakes. Additionally, a monitoring system may be placed in a playroom to monitor the safety of several children playing together. Essentially, the monitoring system may provide a set of ears to alert parents to potential problems involving their child.

Typically, the monitoring, or alerting, systems include a transmitter and a receiver that operate wirelessly with each other. Such a wireless link, however, between the transmitter and receiver normally has a small range. A parent, therefore, may have to keep the receiver close to the location of their child to receive any benefit from the monitoring system.

Accordingly, what is needed in the art is a more versatile monitoring system that is inexpensive to implement, simple to use and reliably provides an alert over short and long distances.

### SUMMARY OF THE INVENTION

To address the above-discussed deficiencies of the prior art, the present invention provides a method of monitoring a location. In one embodiment, the method includes detecting a sound at a monitoring location and determining if the sound is above a predetermined threshold. The method also includes sending a message to a location distal from the monitoring location if the sound is above the predetermined threshold.

The present invention, therefore, provides a method of monitoring that monitors a person or object over a distance which may vary. The distance between the location and the receiver may vary when either the location, the receiver or both are moved. In a preferred embodiment, the method sends a Short Messaging Service (SMS) message when the sound, or noise, is detected having a strength greater than the predetermined threshold value.

In another aspect, the present invention provides a mobile phone that includes a detector configured to detect a sound and a discriminator configured to determine if the sound is above a predetermined threshold. The mobile phone also includes a transmitter configured to send a message to a location distal from the mobile phone if the sound is above the predetermined threshold.

According to another aspect, the present invention provides a mobile phone that includes a means for detecting a sound and a means for discriminating that determines when the sound is above a predetermined threshold value. The mobile phone also includes a means for sending that sends a message to a location distal from the mobile phone if the sound is above the predetermined threshold.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following description taken in conjunction with the accompanying drawings, in which:

FIG. 1 illustrates a network diagram of an embodiment of a monitoring system constructed in accordance with the principles of the present invention.

### DETAILED DESCRIPTION

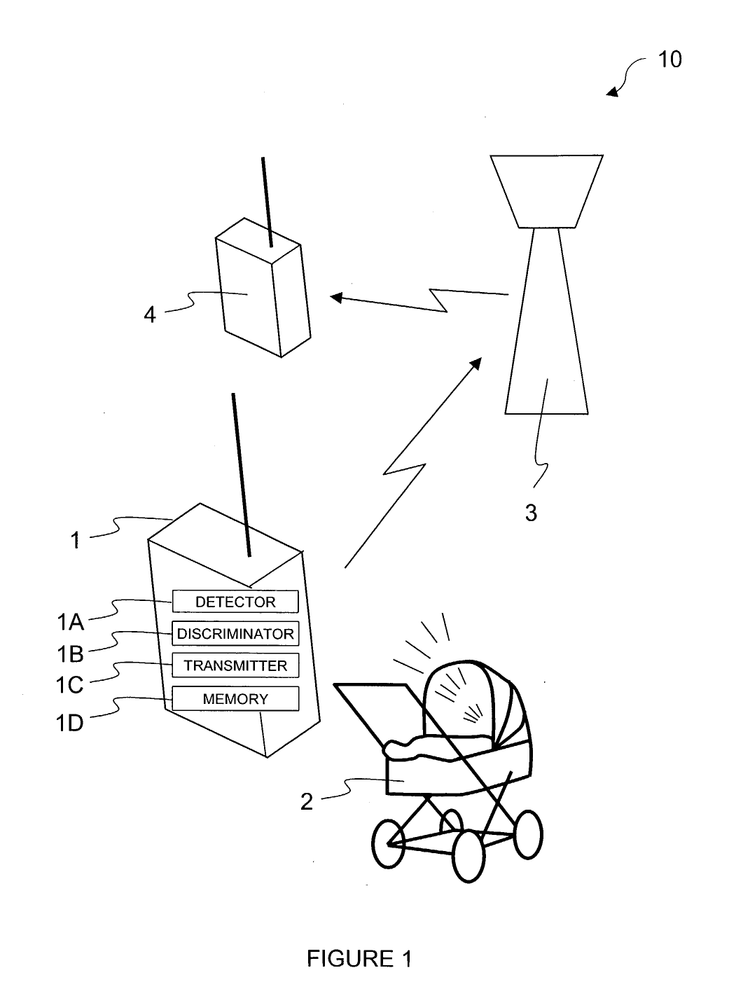

Referring to FIG. 1, illustrated is a network diagram of an embodiment of a monitoring system, generally designated 10, constructed in accordance with the principles of the present invention. The monitoring, or alerting, system 10 includes a mobile phone 1, a monitoring location 2, a radio network 3 and a receiver 4.

The mobile phone 1 may include, among other things, a detector (i.e., means for detecting noise) 1A, a discriminator (i.e., means for discriminating) 1B, a transmitter (i.e., means for sending) 1C. The detector 1A may include a conventional microphone of the mobile phone 1 coupled to the discriminator 1B. The discriminator 1B may be a dedicated component that is constructed of special-purpose hardware employing a sequence of operating instructions which directs its operation of course, the discriminator 1B may be solely hardwired or a general purpose component that is solely software enabled. In one embodiment, the discriminator 1B may be a digital signal processor.

The transmitter 1C may be coupled to the discriminator 1B and memory 1D (i.e., means for storing). The transmitter 1C and memory 1D may be a conventional transmitter and a conventional memory device commonly located within a standard mobile phone. The transmitter 1C may be capable of sending a Short Messaging Services (SMS) message from the monitoring location 2 to another telecommunications device, such as the receiver 4, via the radio network 3.

The monitoring location 2 may be any location a subscriber desires to monitor. As illustrated, the monitoring location 2 may include a stroller having a baby therein. Of course one skilled in the art will understand that the monitoring location 2 may be another location that does not include a stroller. For example, the monitoring location 2 may include machinery that the subscriber desires to monitor.

The radio network 3 may be a standard telecommunications network that supports communications between mobile phones or other telecommunications devices. In some embodiments, the radio network 3 may be capable of converting an SMS message to a fax message. In other embodiments, the radio network may be capable of converting a SMS message into a voice message. Accordingly, the receiver 4 may have appropriate components to produce an audible alert. The audible alert may be, for example, a voice or designated sound.

The receiver 4 may be a telecommunications device capable of receiving a SMS message. The receiver 4 may be a conventional mobile phone capable of receiving a wireless phone call and a SMS message. In some embodiments, the receiver 4 may be capable of receiving a fax message.

Typically, the mobile phone 1 is located some distance from the receiver 4. The detector 1A of the mobile phone 1 may detect a sound that is sent to the discriminator 1B. The discriminator 1B may determine if the detected sound is above or below a predetermined threshold value. If the sound is above the predetermined threshold value, the discriminator 1B may activate the transmitter 1C to send a message. The transmitter 1C may send a SMS message via the radio network 3 to the receiver 4. The receiver 4 may be alerted to the detected sound at the monitoring location 2 upon receipt of the SMS message.

In another embodiment, the radio network 3 may convert the SMS message to a fax message to alert the receiver 4. In other embodiments, the radio network 3 may convert the SMS message to a voice message to alert the receiver 4. Additionally, the mobile phone 1 may alert the receiver 4 employing another type of message. In some embodiments, the mobile phone 1 may send a prerecorded voice message or may send the detected sound or sounds. For example, after the discriminator 1B determines an alert is needed, the mobile phone 1 may activate a number for the receiver 4 from the memory 1D that the transmitter 1C employs to call the receiver 4. Once the receiver 4 answers the call, the connection between the mobile phone 1 and the receiver 4 is completed.

The monitoring system 10 may also verify that the receiver 4 received the message. For example, the mobile phone 1 may send a request for notification of delivery of the SMS message to the receiver 4. If the notification is not received by the mobile phone 1 within a predetermined time period, the SMS message may be sent again. In some embodiments, the SMS message may be sent until the notification is received. In other embodiments, the SMS message may be sent for a predetermined number of times. Of course one skilled in the art will understand that a request for notification may also be sent if another type of alerting message besides a SMS message is sent by the mobile phone 1.

In some embodiments, the mobile phone 1 may alert more telecommunication devices than the receiver 4. For example, the memory 1D may include the destination numbers of several receivers. Normally, a number for the receiver 4 is chosen when the monitoring system 10 is activated. The memory 1D, however, may be programmable via a user dialog to enable sending a message to several receivers when the monitoring system 10 is activated. Additionally, the value of the threshold may be programmable, for example, via a user dialog.

The present invention, therefore, provides a method of monitoring a location and a mobile phone that may advantageously expand the distance between a monitoring location and a receiver compared to existing monitoring systems. In addition, the method for monitoring may employ a SMS message to alert the receiver or receivers when needed based on a user programmable threshold value. Furthermore, specialized equipment simply designated for monitoring is not needed.

Although the present invention has been described in detail, those skilled in the art should understand that they can make various changes, substitutions and alterations herein without departing from the spirit and scope of the invention in its broadest form.

What is claimed

1. A method of monitoring a location, comprising:
detecting a sound at a monitoring location;
determining if the sound is above a predetermined threshold; and
sending a message to a location distal from the monitoring location if the sound is above the predetermined threshold.

2. The method as recited in claim 1 further comprising storing destination numbers to send the message.

3. The method as recited in claim 1 further comprising sending a request for notification of delivery of the message.

4. The method as recited in claim 1 further comprising resending the message if a predetermined time period has lapsed.

5. The method as recited in claim 1 wherein the message is selected from the group consisting of:
a Short Message Service (SMS) message,
a fax message, and
a voice message.

6. A mobile phone, comprising:
a detector configured to detect a sound;
a discriminator configured to determine if the sound is above a predetermined threshold; and
a transmitter configured to send a message to a location distal from the mobile phone if the sound is above the predetermined threshold.

7. The mobile phone as recited in claim 6 further comprising memory configured to store destination numbers to send the message.

8. The mobile phone as recited in claim 6 wherein the transmitter is configured to send a request for notification of delivery of the message.

9. The mobile phone as recited in claim 6 wherein the transmitter is configured to resend the message if a predetermined time period has lapsed.

10. The mobile phone as recited in claim 6 wherein the message is selected from the group consisting of:
a Short Message Service (SMS) message,
a fax message, and
a voice message.

11. The mobile phone as recited in claim 6 wherein the detector comprises a microphone.

12. The mobile phone as recited in claim 6 wherein the transmitter is configured to send the message to a receiver located distal from the mobile phone via a radio network.

13. A mobile phone comprising:
means for detecting a sound;
means for discriminating that determines when the sound is above a predetermined threshold value; and
means for sending that sends a message to a location distal from the mobile phone if the sound is above the predetermined threshold.

14. The mobile phone as recited in claim 13 further comprising means for storing that stores destination numbers to send the message.

15. The mobile phone as recited in claim 13 wherein the means for sending sends a request for notification of delivery of the message.

16. The mobile phone as recited in claim 13 wherein the means for sending resends the message if a predetermined time period has lapsed.

17. The mobile phone as recited in claim 13 wherein the message is selected from the group consisting of:
a Short Message Service (SMS) message,
a fax message, and
a voice message.

18. The mobile phone as recited in claim 13 wherein the means for detecting comprises a microphone.

19. The mobile phone as recited in claim 13 wherein the means for sending sends the message to a receiver located distal from the mobile phone via a radio network.

20. The mobile phone as recited in claim 13 wherein the means for discriminating is embodied in a digital signal processor.
